(19) United States
(12) Patent Application Publication
(10) Pub. No.: US 2003/0168511 A1
(43) Pub. Date: Sep. 11, 2003

(54) Card reader system for installed in a personal computer

(76) Inventor: Chia-Hsun Lin, Miao-Lih Hsuan (TW)

Correspondence Address: PERKINS COIE LLP, PATENT-SEA, P.O. BOX 1247, SEATTLE, WA, 98111-1247, US

(21) Appl. No.: 10/136,739

(22) Filed: Apr. 30, 2002

(30) Foreign Application Priority Data
Mar. 7, 2002 (TW) 091202706

(51) Int. Cl. G06K 7/06

(52) U.S. Cl. 235/441

(57) ABSTRACT

The present invention discloses the card readers installed in personal computer. The built-in card readers of personal computer include a personal computer; a plurality card reader units, wherein the plurality card reader units are installed in the personal computer mainframe, each of the card reader units containing plurality connectors, the plurality card reader units electrical connecting with the personal computer by using a transmission interface, the connector connecting with other connectors in the card readers and periphery circuit devices, and inserting memory cards into the connectors, thereby reading the memory cards data.

### BACKGROUND OF THE INVENTION

1. Field of the Invention

The present invention relates to a card reader system, and more specifically, to the system of a multi-function card reader installed in a personal computer.

2. Description of the Prior Art

In recent years, many different kinds of cards have become more popular and have been widely used. Credit cards, bank cards, identification cards and many other cards are used in our increasingly complicated and rapidly changed society. More recently, a memory card or a smart card haying an integrated circuit (IC) memory chip has been developed with increased capability of storing data, which can hold much more information than a magnetic strip type card. Use of the memory cards is rapidly increasing in the banking industry and for the purpose of storing personal data, such as electronic identification cards, driver's licenses, social security cards, financial cards and others.

To access the information stored on the memory card, the card reader should be equipped with a connector making an electrical connection with the contact elements of the semiconductor device, e.g. the IC chip.

The many readers that are in existence have the common feature of operation achieved by a microprocessor of their own that manages the sampling of an input/output line of the card and the associated transmission protocol. Furthermore, the microprocessor of the reader also provides for the interfacing with the microcomputer. Each reader therefore has a microprocessor whose design is developed to a greater or lesser extent and has a considerable effect on the cost of the reader.

The cards accepted by each reader and the protocols of transmission to the microcomputer are fixed in the microprocessor of the reader. This microprocessor finds out whether it can process the card presented to it and, together with the microcomputer, decides on the transmission protocol.

The connection of a card reader to the microcomputer is done by means of a connector or port on the microcomputer. This therefore necessitates a specific port for the card reader on each microcomputer. This is a drawback because it is useful, for reasons of cost or flexibility of use, to reduce the number of ports in the microcomputer.

The common method of reading memory cards by using card reader is which inserted the memories into connectors' base of the card reader, then read the stored data in memory cards by using the card reader connecting a computer. Especially, the card reader is the outer computer and separate with the computer. Therefore, we must carry a computer and a card reader simultaneously in reading the memory cards data. If the card reader does not carry, reading the memory cards will be cut off. It wastes much time that the card reader needs connecting to the computer in read memory cards data.

For the above reasons, it is desired to find a more preferable card reader system.

### SUMMARY OF THE INVENTION

The main object of the present invention is that the user does not need to bring a card reader with oneself, and the user can easily operate the read reader system to read many different kinds memory cards.

The present invention provides a system of a card reader installed in a personal computer. The card reader system include a personal computer; a plurality card reader units, wherein the plurality card reader units are installed in the personal computer mainframe, each of the card reader units containing plurality connectors, the plurality card reader units electrical connecting with the personal computer by using a transmission interface, the connector connecting with other connectors in the card reader units and periphery circuit devices, and inserting memory cards into the connectors, thereby reading the memory cards data.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the schematic diagram of a card reader of personal computer according to the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

The present invention discloses a system of card reader installed in a personal computer. The card reader system include a personal computer; a plurality card reader units, wherein the plurality card reader units are installed in the personal computer mainframe, each of the card reader units containing plurality connectors, the plurality card reader units electrical connecting with the personal computer by using a transmission interface, a connector connecting with other connectors in the card reader units and periphery circuit devices, and inserting memory cards into the connectors, thereby reading the memory cards data.

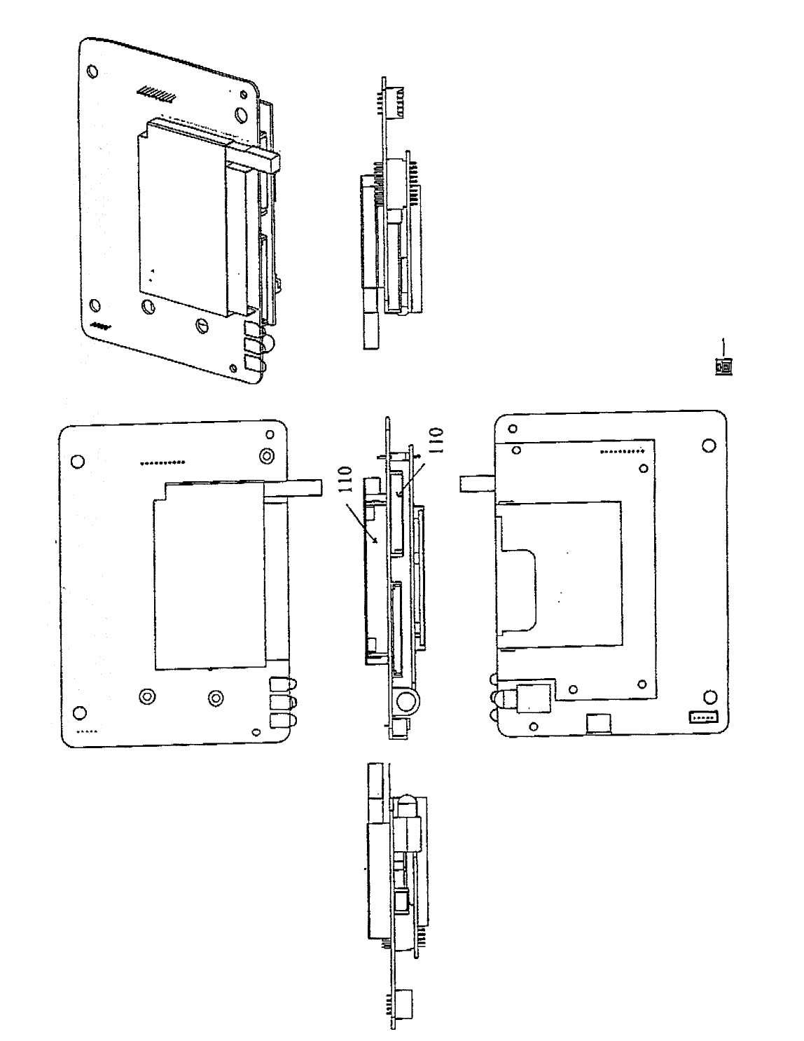

FIG. 1 is the schematic diagram of a card reader of personal computer according to the present invention.

Referring to FIG. 1, this is the schematic diagram of a card reader unit 100 of a personal computer according to the present invention. The computer card reader is made of card reader units by stacking multilayer the connectors, and the card reader is installed in the computer. The personal computer is the desktop personal computer, and contains mainframe, connecting wires and monitor. The card reader units 100 are installed into the main frame of the computer, and the installing method of the card reader units are adopting a fixed style or a movable style. The installing method of the card reader units 100 depends on the size design of the personal computer or user's utilities.

The installing method of the fixed style is to fasten card reader on fixed position of computer main frame. Owing to such installing method, the memory cards base configuration fail to the front and rear connection. This will reduce the allowable memory card members. The installing method of the movable style is also to fasten card reader on fixed position of computer main frame, but the card reader can draw out. It is convenient to insert or change memory cards. The memory cards base configuration can achieve the front and rear connection, so it will add the allowable memory card members. That is to say, the above card reader installing method will prepare a fixed space to install. The installing method of the fixed style can not use the mutual space with other machine parts, for example, hard discs, soft discs . . . etc. However, the installing method of the movable style can use the mutual space with other machine parts. Therefore, the computer main frame space configuration with the card reader configuration must be arranged again.

The card reader units 100 configuration can stack the connectors by using multilayer stacking method. This not only reduces card reader size, but also uses simultaneously many different kinds memory cards to read the plurality memory cards.

Each of the card reader units 100 contains plurality connectors, and the plurality card reader units connect electrically with the personal computer by using a transmission interface. A connector connects with other connectors in the card reader and periphery circuit devices. Next, the memory cards are inserted into the connectors to read the memory cards data.

The personal computer of above personal computer card reader system includes a notebook personal computer or a bench top personal computer.

Therefore, the advantage of the present invention is that the user does not bring to the card reader in using the personal computer card reader system. It is convenient to use. Moreover, stacking the connectors by using stacking multilayer method can read many different kinds plurality memory cards.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

What is claimed is:

1. A system of card reader installed in a personal computer comprising:
a personal computer;
a plurality card reader units, wherein said plurality card reader units are installed in said personal computer, each of said card reader units containing plurality connectors, said plurality card reader units electrical connecting with said personal computer by using a transmission interface, said connector connecting with said other connectors in said card reader and periphery circuit devices, and inserting memory cards into said connectors, thereby reading said memory cards data.

2. The system of card reader of claim 1, wherein said personal computer is a desktop personal computer.

3. The system of card reader of claim 1, wherein said personal computer is a notebook personal computer.

4. The system of card reader of claim 1, wherein said card reader units are made of computer card reader by stacking multilayer the connectors.

5. The system of card reader of claim 1, wherein said card reader said installing method is adopted a fixed style.

6. The system of card reader of claim 1, wherein said card reader said installing method is adopted a movable style.
